(19) United States
(12) Patent Application Publication
(10) Pub. No.: US 2008/0262643 A1
(43) Pub. Date: Oct. 23, 2008

(54) Defect detector for hard disk drive and methods for use therewith

(75) Inventors: John L. Creigh, Rancho Santa Margarita, CA (US); Bahjat Zafer, Cupertino, CA (US); Hooman T. Parizi, Aliso Viejo, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/787,680

(22) Filed: Apr. 17, 2007

(51) Int. Cl. G06F 19/00

(52) U.S. Cl. 700/110

(57) ABSTRACT

A defect detector a hard disk drive includes a signal energy processor that produces at least one energy signal from a plurality of read samples. A comparator module compares the at least one energy signal to at least one corresponding energy threshold and generates defect data when the at least one energy signal compares unfavorably to the at least one corresponding energy threshold.

### CROSS REFERENCE TO RELATED PATENTS

Not applicable

### BACKGROUND OF THE INVENTION

Technical Field of the Invention

The present invention relates to disk drives and read head processing to detect defects during disk formatting.

Description of Related Art

As is known, many varieties of disk drives, such as magnetic disk drives are used to provide data storage for a host device, either directly, or through a network such as a storage area network (SAN) or network attached storage (NAS). Typical host devices include stand alone computer systems such as a desktop or laptop computer, enterprise storage devices such as servers, storage arrays such as a redundant array of independent disks (RAID) arrays, storage routers, storage switches and storage directors, and other consumer devices such as video game systems and digital video recorders. These devices provide high storage capacity in a cost effective manner.

As a magnetic hard drive is manufactured it is formatted at the factory. The formatting process typically includes at least one stage where data is read to the drive in a physical mode corresponding to the physical parameters of the drive. For example, a disk drive with 1024 cylinders, 256 heads and 63 sectors per track has (1024)×(256)×(63)=16,515,072 sectors. Each sector can be physically addressed based on its corresponding cylinder, head and sector number, e.g. cylinder 437, head 199, sector 12. Various imperfections in the magnetic medium can cause problems with reading data to and from the disk. Areas of thin magnetic material can cause low signal returns and data dropouts. Raised features on the disk can make contact with the read head. The resulting friction can increase the temperature of the read head. This thermal asperity can cause an increase in signal amplitude or data dropins. During manufacture, a test pattern is written to, and read from, each disk sector in physical mode to determine which sectors of the disk are good and are available for storage, and which sectors are bad and should not be used. The effective detection of defects can improve the performance of magnetic disk drives by efficiently and accurately identifying defective areas.

### BRIEF DESCRIPTION OF THE SEVERAL VIEWS OF THE DRAWINGS

FIG. 1 presents a pictorial representation of a disk drive unit 100 in accordance with an embodiment of the present invention.

FIG. 2 presents a block diagram representation of a disk controller 130 in accordance with an embodiment of the present invention.

FIG. 3 presents a block diagram representation of a defect detector 225 in conjunction with components of disk controller 130 in accordance with an embodiment of the present invention.

FIG. 4 presents a block diagram representation of a defect detector 225 in accordance with an embodiment of the present invention.

FIG. 5 presents a block diagram representation of a comparator module 234 in accordance with an embodiment of the present invention.

FIG. 6 presents a block diagram representation of a comparator module 235 in accordance with an embodiment of the present invention.

FIG. 7 presents a block diagram representation of a signal energy processor 230 in accordance with an embodiment of the present invention.

FIG. 8 presents a block diagram representation of a signal energy processor 231 in accordance with an embodiment of the present invention.

FIG. 9 presents a pictorial representation of a handheld audio unit 51 in accordance with an embodiment of the present invention.

FIG. 10 presents a pictorial representation of a computer 52 in accordance with an embodiment of the present invention.

FIG. 11 presents a pictorial representation of a wireless communication device 53 in accordance with an embodiment of the present invention.

FIG. 12 presents a pictorial representation of a personal digital assistant 54 in accordance with an embodiment of the present invention.

FIG. 13 presents a pictorial representation of a laptop computer 55 in accordance with an embodiment of the present invention.

FIG. 14 presents a flowchart representation of a method in accordance with an embodiment of the present invention.

FIG. 15 presents a flowchart representation of a method in accordance with an embodiment of the present invention.

FIG. 16 presents a flowchart representation of a method in accordance with an embodiment of the present invention.

### SUMMARY OF THE INVENTION

The present invention sets forth a disk formatter and methods for use therewith substantially as shown in and/or described in connection with at least one of the figures, as set forth more completely in the claims that follow.

### DETAILED DESCRIPTION OF THE INVENTION INCLUDING THE PRESENTLY PREFERRED EMBODIMENTS

The present invention provides several advantages over the prior art. In an embodiment of the present invention, a defect detector for use in a hard disk drive is presented that uses signal energy as a basis for detecting defects during disk formatting and generates defect data that can be used to identify bad disk sectors and for generating other diagnostics and/or control. The defect detector is programmable to different test patterns, including test patterns of different lengths that can be used in, for instance, with either longitudinal magnetic recording (LMR) or perpendicular magnetic recording (PMR) heads.

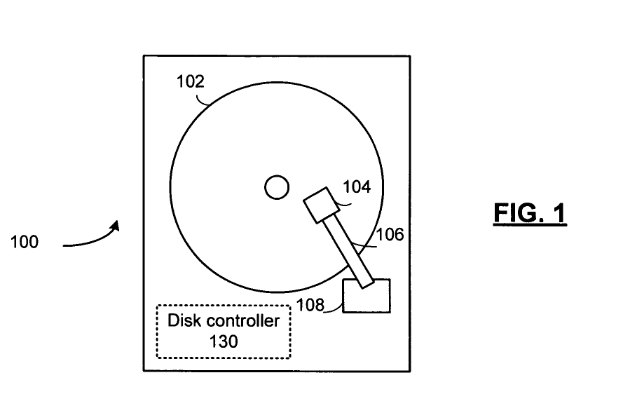

FIG. 1 presents a pictorial representation of a disk drive unit 100 in accordance with an embodiment of the present invention. In particular, disk drive unit 100 includes a disk 102 that is rotated by a servo motor (not specifically shown) at a velocity such as 3,600 revolutions per minute (RPM), 4,200 RPM, 4,800 RPM, 5,400 RPM, 7,200 RPM, 10,000 RPM, 15,000 RPM, however, other velocities including greater or lesser velocities may likewise be used, depending on the particular application and implementation in a host device. In an embodiment of the present invention, disk 102 can be a magnetic disk that stores information as magnetic field changes on some type of magnetic medium. The medium can be a rigid or nonrigid, removable or nonremovable, that consists of or is coated with magnetic material.

Disk drive unit 100 further includes one or more read/write heads 104 that read and write data to the disk via longitudinal magnetic recording (LMR), and/or perpendicular magnetic recording (PMR). The read/write heads 104 are coupled to arm 106 that is moved by actuator 108 over the surface of the disk 102 either by translation, rotation or both. A disk controller 130 is included for controlling the read and write operations to and from the drive, for controlling the speed of the servo motor and the motion of actuator 108, and for providing an interface to and from the host device. Disk controller 130, provides one or more functions or features of the present invention, as described in further detail in conjunction with the figures that follow.

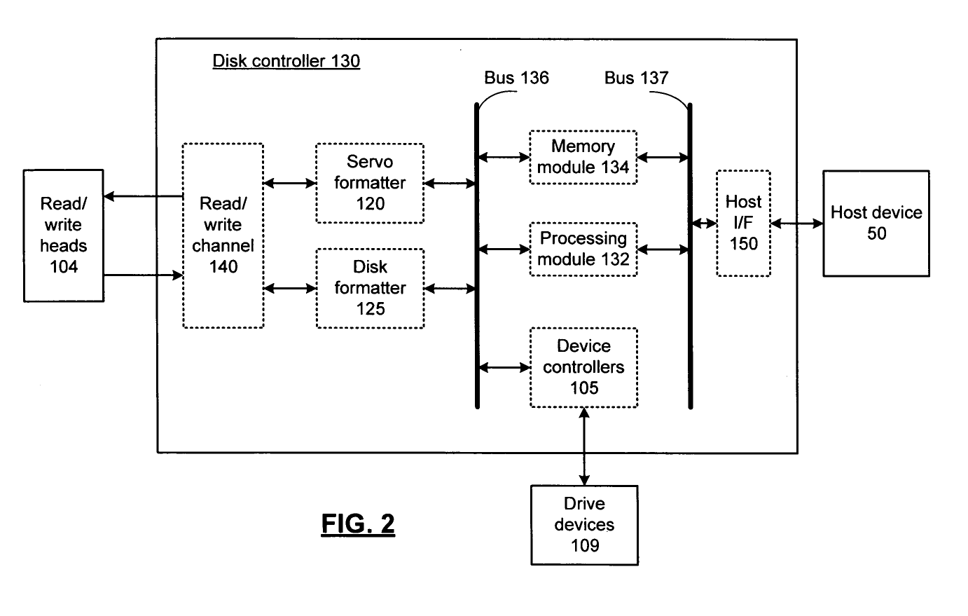

FIG. 2 presents a block diagram representation of a disk controller 130 in accordance with an embodiment of the present invention. In particular, disk controller 130 includes a read/write channel 140 for reading and writing data to and from disk 102 through read/write heads 104. Disk formatter 125 is included for controlling the formatting of data and provides clock signals and other timing signals that control the flow of the data written to, and data read from disk 102 servo formatter 120 provides clock signals and other timing signals based on servo control data read from disk 102, device controllers 105 control the operation of drive devices 109 such as actuator 108 and the servo motor, etc. Host interface 150 receives read and write commands from host device 50 and transmits data read from disk 102 along with other control information in accordance with a host interface protocol. In an embodiment of the present invention the host interface protocol can include, SCSI, SATA, enhanced integrated drive electronics (EIDE), or any number of other host interface protocols, either open or proprietary that can be used for this purpose.

Disk controller 130 further includes a processing module 132 and memory module 134. Processing module 132 can be implemented using a shared processing device or dedicated processing device that includes one or more microprocessors, micro-controllers, digital signal processors, microcomputers, central processing units, field programmable gate arrays, programmable logic devices, state machines, logic circuits, analog circuits, digital circuits, and/or any devices that manipulates signal (analog and/or digital) based on operational instructions that are stored in memory module 134. When processing module 132 is implemented with two or more devices, each device can perform the same steps, processes or functions in order to provide fault tolerance or redundancy. Alternatively, the function, steps and processes performed by processing module 132 can be split between different devices to provide greater computational speed and/or efficiency.

Memory module 134 may be a single memory device or a plurality of memory devices. Such a memory device may be a read-only memory, random access memory, volatile memory, non-volatile memory, static random access memory (SRAM), dynamic random access memory (DRAM), flash memory, cache memory, and/or any device that stores digital information. Note that when the processing module 132 implements one or more of its functions via a state machine, analog circuitry, digital circuitry, and/or logic circuitry, the memory module 134 storing the corresponding operational instructions may be embedded within, or external to, the circuitry comprising the state machine, analog circuitry, digital circuitry, and/or logic circuitry. Further note that, the memory module 134 stores, and the processing module 132 executes, operational instructions that can correspond to one or more of the steps of a process, method and/or function illustrated herein.

Disk controller 130 includes a plurality of modules, in particular, device controllers 105, processing module 132, memory module 134, read/write channel 140, disk formatter 125, servo formatter 120 and host interface 150 that are interconnected via buses 136 and 137. Each of these modules can be implemented in hardware, firmware, software or a combination thereof, in accordance with the broad scope of the present invention. While a particular bus architecture is shown in FIG. 2 with buses 136 and 137, alternative bus architectures that include either a single bus configuration or additional data buses, further connectivity, such as direct connectivity between the various modules, are likewise possible to implement the features and functions included in the various embodiments of the present invention.

In an embodiment of the present invention, one or more modules of disk controller 130 are implemented as part of a system on a chip integrated circuit. In an embodiment of the present invention, this system on a chip integrated circuit includes a digital portion that can include additional modules such as protocol converters, linear block code encoding and decoding modules, etc., and an analog portion that includes additional modules, such as a power supply, disk drive motor amplifier, disk speed monitor, read amplifiers, etc. In a further embodiment of the present invention, the various functions and features of disk controller 130 are implemented in a plurality of integrated circuit devices that communicate and combine to perform the functionality of disk controller 130.

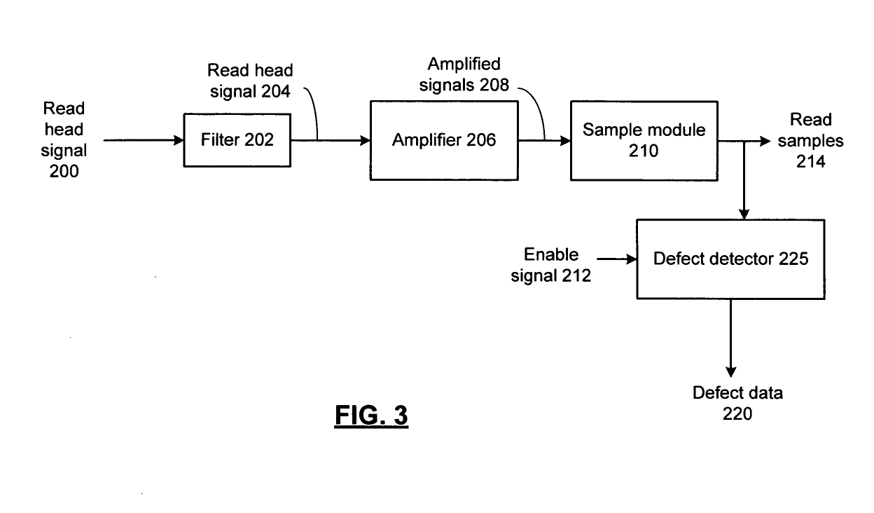

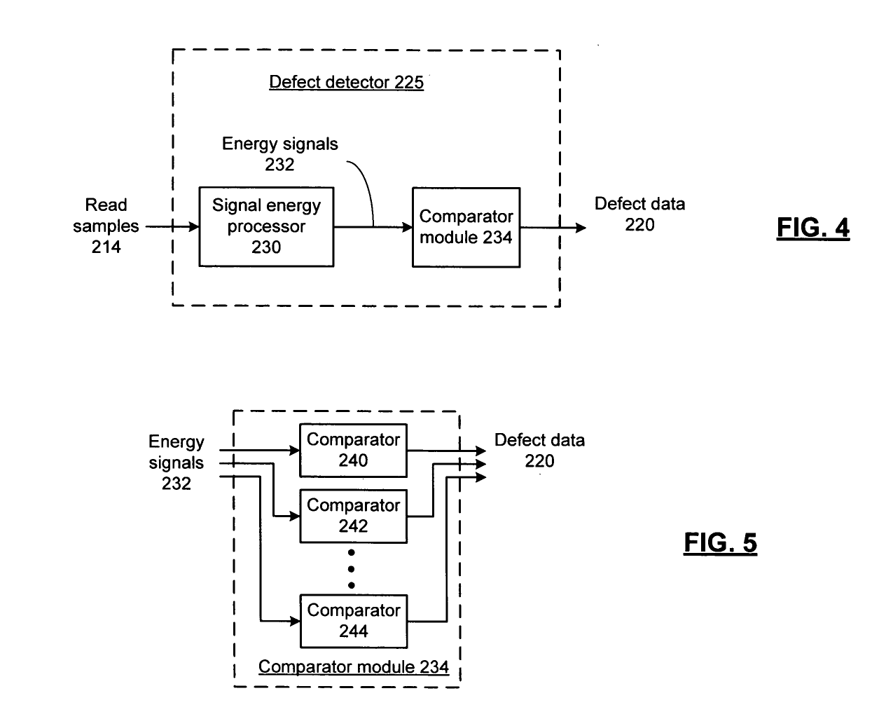

Disk controller 130 includes a defect detector in accordance with the present invention that will be described in greater detail in conjunction with FIGS. 3 and 4 that follow.

FIG. 3 presents a block diagram representation of a defect detector 225 in conjunction with components of disk controller 130 in accordance with an embodiment of the present invention. In particular, read head signal 200 from a read head is optionally filtered or otherwise processed by filter 202 to produce read head signal 204 that is amplified by amplifier 206 to produce amplified signals 208. The amplified signals 208 are sampled by sample module 210 to produce read samples 214 that are used by a read/write channel, such as read/write channel 140 to produce read data, such as, control and payload data from the disk, data to control the operation of drive devices 109, and data to format the disk drive, either during initial set-up of the drive or subsequent formatting of the drive. Defect detector 225, when enabled in response to enable signal 212 detects one or more different types of defects such as short, medium and/or long period data dropouts and/or dropins and generates defect data 220 in response thereto.

In an embodiment of the present invention, the defect detector 225 is enabled during formatting of the disk drive 100, either during initial setup of the disk or during a subsequent reformatting of the drive. During formatting, each sector of the disk 102 is written with a bit pattern, such as a 2T pattern or other test pattern, that can be used to test the read/write ability of the various sectors. The data from each sector of the disk is read and compared with the pattern. In these cases, the defect data 220 is used by the disk controller 130 to map out bad sectors of the disk 102 during the formatting and reformatting processes. The defect detector 225 can optionally be disabled when not in use.

In a further embodiment of the present invention, the defect detector 225 can be enabled during normal operation of the disk drive 100 and the defect data 220 can be used by disk controller 130 to adjust, hold or control other control parameters such as to freeze system gains and/or control loops, such as servo control loops of the disk drive, during the duration of a data dropin or dropout, to avoid undesired adaptation based on transient conditions.

FIG. 4 presents a block diagram representation of a defect detector 225 in accordance with an embodiment of the present invention. In particular, defect detector 225 includes a signal energy processor 230 that produces one or more energy signals from a plurality of read samples 214. In an embodiment of the present invention, the signal energy processor 230 calculates signal energy over a plurality of different sample sizes such as 4, 8, 12, 16, 24 and/or 32, samples, however, other sample sizes may likewise be employed including, based on the period of the particular test data that is used or based on other design factors such as anticipated defect lengths.

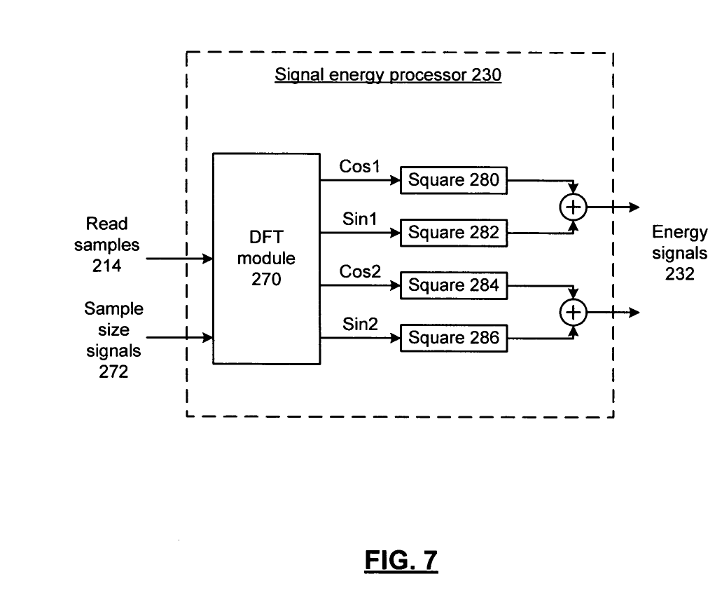

For example, if a 2T pattern (110011001100 . . . ) is used as the test data during disk formatting with a test data period of size 4, one energy signal 232 can be generated with a sample size of 4, that calculates the signal energy over a short interval of 4 read samples 214. In this fashion, defects of a short duration can be detected. In addition, other energy signals 232 with longer sample sizes, such as 8, 16 or longer, can also be generated to more effectively detect defects of medium or long length. Further, if a 4T pattern (1111000011110000 . . . ) is used as the test data during disk formatting with a test data period of size 8, one energy signal 232 can be generated with a sample size of 8, that calculates the signal energy over a short period of 8 read samples 214. In this fashion, defects of a short duration can be detected. In addition, other energy signals 232 with longer sample sizes, such as 16, 32 or longer, can also be generated to more effectively detect defects of medium or long length. In short, signal energy processor 230 can be programmed to generate a plurality of energy signals having different sample sizes. These sample sizes can be varied independently based on anticipated defect lengths, based on the particular test data period that is employed or based on other design considerations. Further embodiments including optional implementations of signal energy processor 230 are presented in conjunction with FIGS. 7 and 8.

Signal energy processor 230 can be implemented with either a dedicated or shared processing device. Such a processing device, may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in an associated memory. The associated memory may be a single memory device or a plurality of memory devices. Such a memory device may be a read-only memory, random access memory, volatile memory, non-volatile memory, static memory, dynamic memory, flash memory, and/or any device that stores digital information. Note that when the signal energy processor 230 implements one or more of its functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

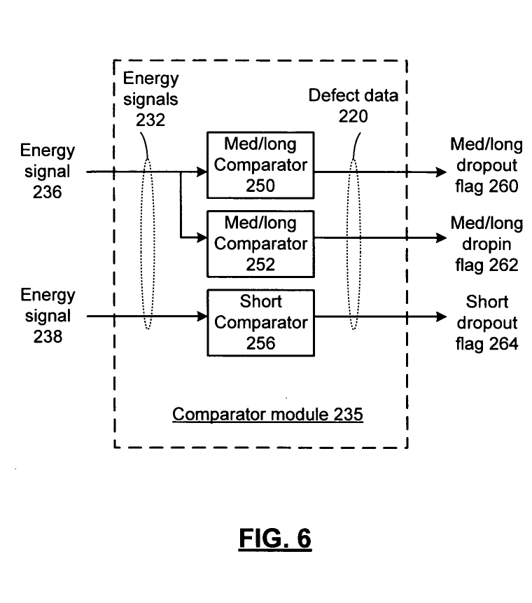

Defect detector 225 further includes a comparator module 234 that compares the energy signals 232 to corresponding energy thresholds and generates defect data 220 when one or more energy signals 232 compare unfavorably to the corresponding energy threshold. Further embodiments including optional implementations of comparator module 234 are presented in conjunction with FIGS. 5 and 6.

FIG. 5 presents a block diagram representation of a comparator module 234 in accordance with an embodiment of the present invention. In particular, comparator module 234 includes a plurality of comparators 240, 242 and 244 for comparing a plurality of energy signals 232 to a plurality of energy thresholds and for generating corresponding components of defect data 220. For instance, comparator 240 can assert a first dropout flag should the corresponding energy signal 232 compare unfavorably (such as to be below) a low energy threshold, indicating the presence of a data dropout. Similarly, comparator 242 can assert a first dropin flag should the corresponding energy signal 232 compares unfavorably (such as to be greater than) a high energy threshold, indicating the present of a data dropin. In addition, other comparators, 244, etc., can be included to compare other energy signals, such as energy signals derived using different sample sizes or other characteristics to other energy thresholds and to generate additional defect data indicating other defects. It should be noted that the comparators 240, 242 and 244 are shown as having a one-to-one correspondence with the plurality of energy signals 232, however, in an alternative embodiment, two or more comparators 240, 242 and/or 244 can also operate from a single energy signal 232, and operate to compare that energy signal to multiple thresholds.

FIG. 6 presents a block diagram representation of a comparator module 235 in accordance with an embodiment of the present invention. Comparator module 235 presents an embodiment of the comparator module 234 that can be implemented in a similar fashion in conjunction with the overall architecture presented in association with FIG. 4. In particular, comparator module 235 includes medium/long comparators 250 and 252 that compare an energy signal 236 derived over a relatively medium or long sample size, to corresponding high and low thresholds. In this embodiment, comparator 250 operates with a low energy threshold that corresponds to a data dropout event and asserts a medium/long dropout flag 260 when energy signal 236 falls below this threshold. Further, comparator 252 operates with a high energy threshold that corresponds to a data dropin event and asserts a medium/long dropin flag 262 when energy signal 236 increases above this threshold. In addition, short comparator 256 compares a second energy signal, derived over a shorter sample size to an additional low energy threshold that corresponds to a data dropout event and asserts a short dropout flag 264 when energy signal 236 falls below this threshold.

FIG. 7 presents a block diagram representation of a signal energy processor 230 in accordance with an embodiment of the present invention. A signal energy processor 230 is shown that generates a plurality of energy signals 232 from a sequence of read samples 214. In particular, signal energy processor 230 includes discrete Fourier transform (DFT) module 270 that produces cosinusoidal and sinusoidal DFT signals having a first sample size (Cos 1 and Sin 1) and a cosinusoidal and sinusoidal DFT signals (Cos 2 and Sin 2) having a second sample size. An energy signal 232, based on the first sample size, is generated by summing a squared sinusoidal signal generated by square module 282 and a squared cosinusoidal signal generated by square module 280. An energy signal 232, based on the second sample size, is generated by summing a squared sinusoidal signal generated by square module 286 and a squared cosinusoidal signal generated by square module 284.

In this embodiment, the DFT module 270 is programmable (via the sample size signals 272, a register value or other input) to a plurality of sample sizes. These sample sizes include the first and second sample size. For instance, if a test data period of 4 samples is employed, the first sample size could be 16 samples and the second sample size could be 4 samples, to correspond to a shorter interval and to correspondingly shorter durations of defects. Further, if a test data period of 8 samples is employed, the first sample size could be 32 samples and the second sample size could be 8 samples, to correspond to a shorter interval and to correspondingly shorter durations of defects. It should be noted that these sample sizes and test data periods are merely illustrative of the broad range of sample sizes that can programmed into the DFT module 270. In addition, while two energy signals 232 are shown, a greater number could likewise be produced in a similar fashion.

FIG. 8 presents a block diagram representation of a signal energy processor 231 in accordance with an embodiment of the present invention. An embodiment of a signal energy processor is shown that can be used in place of signal energy processor 230. In particular signal energy processor 231 generates 4-point, 8-point, 16-point and 32-point DFT sines using a chain of delay elements 300 that may be implemented with a shift register, flip-flops or other logic circuits that can be clocked by the sample clock and that sequentially delays the read samples 214. 4-point DFT sine is generated by subtracting the 3^{rd} delayed sample from the 1^{st} delayed sample as shown. The 8-point DFT sine is generated by subtracting the 7^{th} delayed sample from the 5^{th} delayed sample and adding the 4-point DFT sine. While 8 delay elements are shown, additional delay elements and additional summing elements are similarly configured to generate the 16-point and 32-point DFT sines.

Multiplexer 308 selects the particular sample size to be used (in this case 4, 8, 16 or 32), based on the sample size signals 272. The selected DFT sine is squared in square module 310 to produce the squared sine (Sine 1 Sq.). The squared sine is delayed to produce a squared cosine (Cos 1 Sq.) that is summed with the squared sine to produce an energy signal, such as energy signal 236. In a similar fashion, multiplexer 312 selects the particular sample size to be used (in this case 4, 8), based the other sample size signals 272. The selected DFT sine is squared in square module 310 to produce the squared sine (Sine 2 Sq). The squared sine is delayed to produce a squared cosine (Cos 2 Sq.) that is summed with the squared sine to produce an energy signal, such as energy signal 238.

It should be noted that, as discussed in conjunction with FIG. 4, the architecture for energy signal processor 231 described above is but one possible implementation of a signal energy processor. In particular, energy signal processor 231 could likewise calculate separate DFT cosine terms that are squared separately from the DFT sine terms, could calculate separate DFT cosine terms based on a delay of the DFT sine terms and square these terms separately, or utilize other architectures or algorithms to generate the energy signals 232 based on the read samples 214.

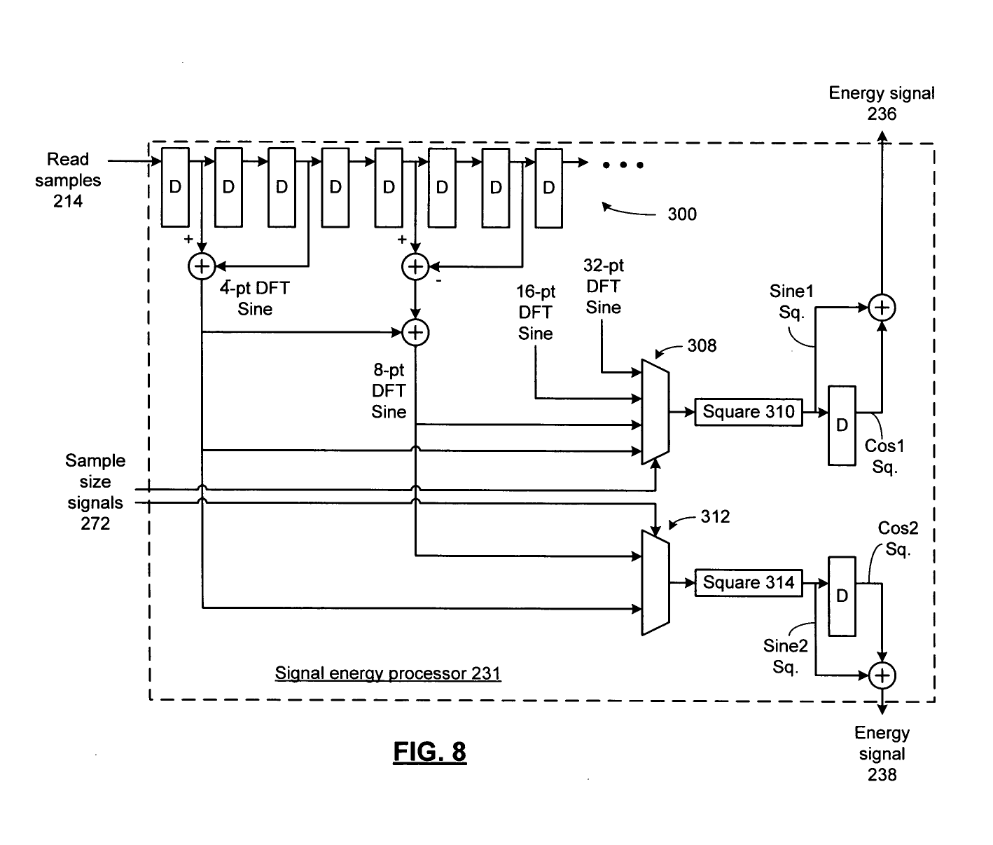

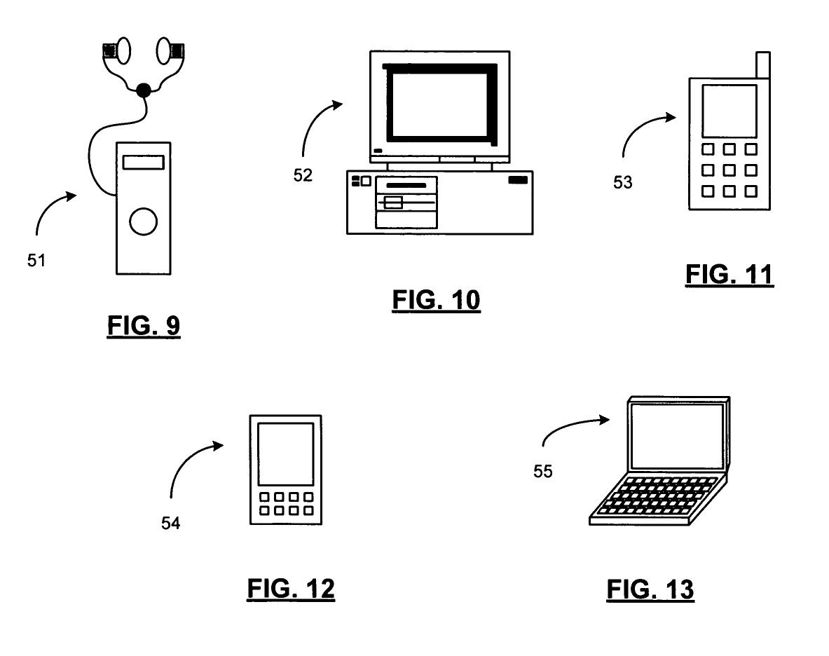

FIG. 9 presents a pictorial representation of a handheld audio unit 51 in accordance with an embodiment of the present invention. In particular, disk drive unit 100 can include a small form factor magnetic hard disk whose disk 102 has a diameter 1.8″ or smaller that is incorporated into or otherwise used by handheld audio unit 51 to provide general storage or storage of audio content such as motion picture expert group (MPEG) audio layer 3 (MP3) files or Windows Media Architecture (WMA) files, video content such as MPEG4 files for playback to a user, and/or any other type of information that may be stored in a digital format.

FIG. 10 presents a pictorial representation of a computer 52 in accordance with an embodiment of the present invention. In particular, disk drive unit 100 can include a small form factor magnetic hard disk whose disk 102 has a diameter 1.8″ or smaller, a 2.5″ or 3.5″ drive or larger drive for applications such as enterprise storage applications. Disk drive 100 is incorporated into or otherwise used by computer 52 to provide general purpose storage for any type of information in digital format. Computer 52 can be a desktop computer, or an enterprise storage devices such a server, of a host computer that is attached to a storage array such as a redundant array of independent disks (RAID) array, storage router, edge router, storage switch and/or storage director.

FIG. 11 presents a pictorial representation of a wireless communication device 53 in accordance with an embodiment of the present invention. In particular, disk drive unit 100 can include a small form factor magnetic hard disk whose disk 102 has a diameter 1.8″ or smaller that is incorporated into or otherwise used by wireless communication device 53 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats that may be captured by an integrated camera or downloaded to the wireless communication device 53, emails, webpage information and other information downloaded from the Internet, address book information, and/or any other type of information that may be stored in a digital format.

In an embodiment of the present invention, wireless communication device 53 is capable of communicating via a wireless telephone network such as a cellular, personal communications service (PCS), general packet radio service (GPRS), global system for mobile communications (GSM), and integrated digital enhanced network (iDEN) or other wireless communications network capable of sending and receiving telephone calls. Further, wireless communication device 53 is capable of communicating via the Internet to access email, download content, access websites, and provide streaming audio and/or video programming. In this fashion, wireless communication device 53 can place and receive telephone calls, text messages such as emails, short message service (SMS) messages, pages and other data messages that can include attachments such as documents, audio files, video files, images and other graphics.

FIG. 12 presents a pictorial representation of a personal digital assistant 54 in accordance with an embodiment of the present invention. In particular, disk drive unit 100 can include a small form factor magnetic hard disk whose disk 102 has a diameter 1.8″ or smaller that is incorporated into or otherwise used by personal digital assistant 54 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats, emails, webpage information and other information downloaded from the Internet, address book information, and/or any other type of information that may be stored in a digital format.

FIG. 13 presents a pictorial representation of a laptop computer 55 in accordance with an embodiment of the present invention. In particular, disk drive unit 100 can include a small form factor magnetic hard disk whose disk 102 has a diameter 1.8″ or smaller, or a 2.5″ drive. Disk drive 100 is incorporated into or otherwise used by laptop computer 52 to provide general purpose storage for any type of information in digital format.

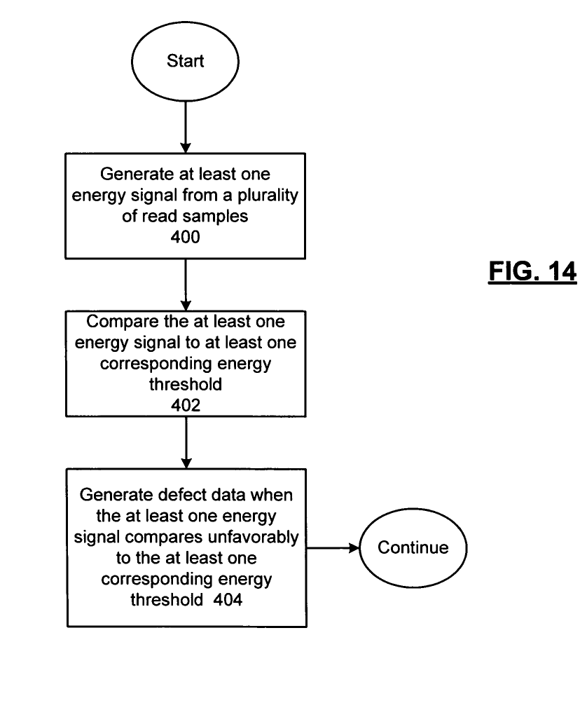

FIG. 14 presents a flowchart representation of a method in accordance with an embodiment of the present invention. In particular, a method is presented that can be used in conjunction with one or more of the features or functions described in association with FIGS. 1-13. In step 400, at least one energy signal is generated from a plurality of read samples. In step 402, the at least one energy signal is compared to at least one corresponding energy threshold. In step 404, defect data is generated when the at least one energy signal compares unfavorably to the at least one corresponding energy threshold.

In an embodiment of the present invention, step 400 includes generating a first DFT signal having a first sample size and a second DFT signal having a second sample size. In addition, the at least one energy signal can include a first energy signal based on the first sample size and a second energy signal based on the second sample size. The at least one energy threshold can include a first energy threshold and step 402 can include comparing the first energy signal to the first energy threshold. Further, the at least one energy threshold can include a second energy threshold and wherein step 402 can include comparing the first energy signal to the second energy threshold. Also, the at least one energy threshold can include a third energy threshold and step 402 can include comparing the second energy signal to the third energy threshold. The first sample size can be longer or shorter than the second sample size. Step 400 can generate the at least one energy signal based on the sum of a squared sinusoidal signal and a squared cosinusoidal signal.

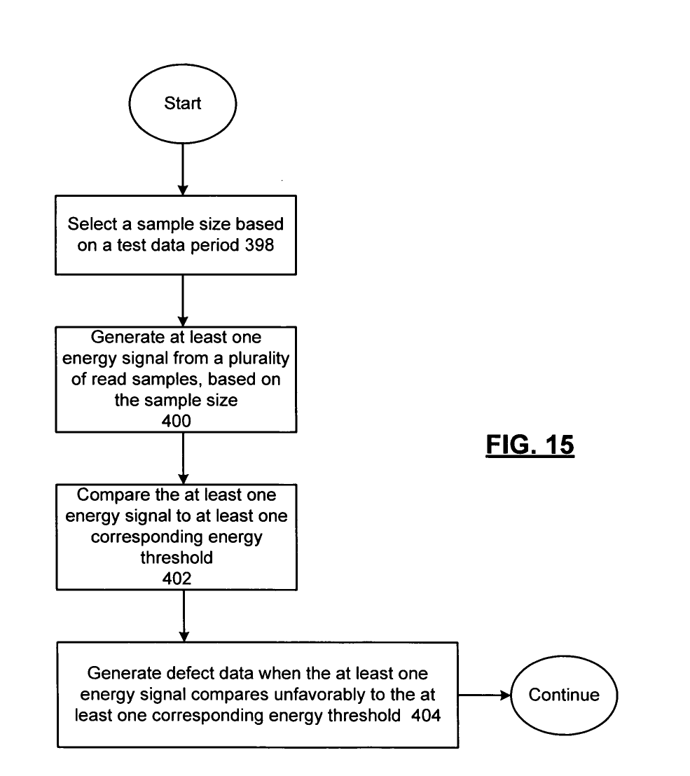

FIG. 15 presents a flowchart representation of a method in accordance with an embodiment of the present invention. In particular, a method is presented that includes many of the steps described in conjunction with FIG. 14 that are referred to by common reference numerals. Further, the read samples used in step 400 include test data having a test data period and step 400 generates the at least one energy signal based on at least one sample size. In addition, step 398 is included for selecting the at least one sample size based on the test data period. In an embodiment of the present invention, the at least one sample size includes a first sample size for use when the hard disk drive is a perpendicular magnetic recording disk drive and a second sample size for use when the hard disk drive a longitudinal magnetic recording disk drive.

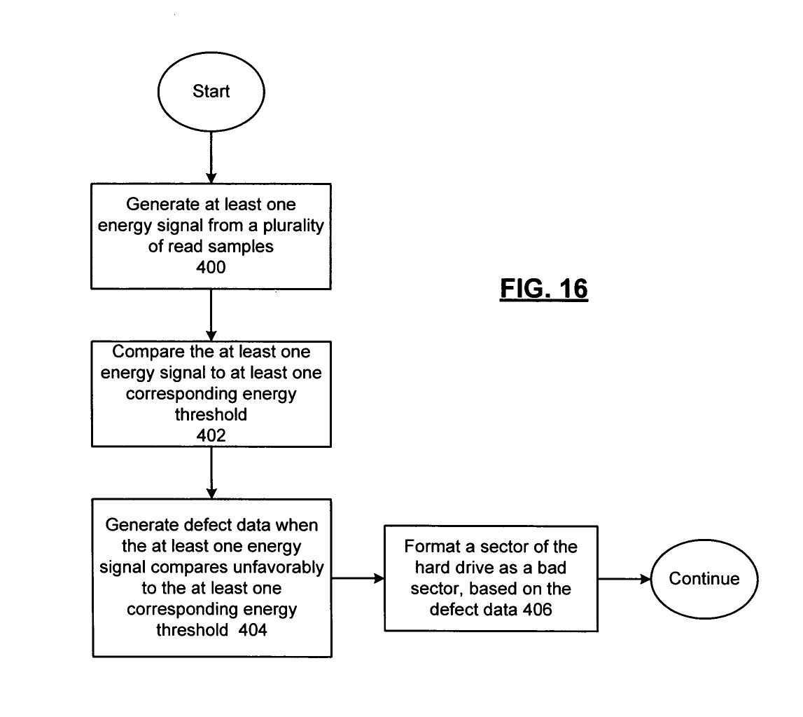

FIG. 16 presents a flowchart representation of a method in accordance with an embodiment of the present invention In particular, a method is presented that includes many of the steps described in conjunction with FIG. 14 that are referred to by common reference numerals. In addition, step 406 is included for formatting a sector of the disk drive as a bad sector based on the defect data.

While the present invention has been described in terms of a magnetic disk, other nonmagnetic storage devices including optical disk drives including compact disks (CD) drives such as CD-R and CD-RW, digital video disk (DVD) drives such as DVD-R, DVD+R, DVD-RW, DVD+RW, etc can likewise be implemented in accordance with the functions and features of the presented invention described herein.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The various circuit components can be implemented using 0.35 micron or smaller CMOS technology. Provided however that other circuit technologies, both integrated or non-integrated, may be used within the broad scope of the present invention. Likewise, various embodiments described herein can also be implemented as software programs running on a computer processor. It should also be noted that the software implementations of the present invention can be stored on a tangible storage medium such as a magnetic or optical disk, read-only memory or random access memory and also be produced as an article of manufacture.

Thus, there has been described herein an apparatus and method, as well as several embodiments including a preferred embodiment, for implementing a memory and a processing system. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. A defect detector for use in a hard disk drive, the defect detector comprising:
a signal energy processor that produces at least one energy signal from a plurality of read samples;
a comparator module, coupled to the signal energy processor, that compares the at least one energy signal to at least one corresponding energy threshold and that generates defect data when the at least one energy signal compares unfavorably to the at least one corresponding energy threshold.

2. The defect detector of claim 1 wherein the plurality of read samples include test data having a test data period and wherein signal energy processor is programmable to a plurality of sample sizes, based on the test data period.

3. The defect detector of claim 2 wherein the plurality of sample sizes include a first sample size for use when the hard disk drive is a perpendicular magnetic recording disk drive and a second sample size for use when the hard disk drive a longitudinal magnetic recording disk drive.

4. The defect detector of claim 1 wherein the signal energy processor includes a discrete Fourier transform (DFT) module that produces a first DFT signal having a first sample size and a second DFT signal having a second sample size.

5. The defect detector of claim 4 wherein the at least one energy signal includes a first energy signal based on the first sample size and a second energy signal based on the second sample size.

6. The defect detector of claim 5 wherein the at least one energy threshold includes a first energy threshold and wherein the comparator module includes a first comparator that compares the first energy signal to the first energy threshold.

7. The defect detector of claim 6 wherein the at least one energy threshold includes a second energy threshold and wherein the comparator module includes a second comparator that compares the first energy signal to the second energy threshold.

8. The defect detector of claim 6 wherein the at least one energy threshold includes a third energy threshold and wherein the comparator module includes a third comparator that compares the second energy signal to the third energy threshold.

9. The defect detector of claim 4 wherein the first sample size is longer than the second sample size.

10. The defect detector of claim 4 wherein the signal energy processor includes programmable values of the first sample size and the second sample size.

11. The defect detector of claim 1 wherein the signal energy processor generates the at least one energy signal based on the sum of a squared sinusoidal signal and a squared cosinusoidal signal.

12. A method for use in a hard disk drive, the method comprising:
generating at least one energy signal from a plurality of read samples;
comparing the at least one energy signal to at least one corresponding energy threshold; and
generating defect data when the at least one energy signal compares unfavorably to the at least one corresponding energy threshold.

13. The method of claim 12 wherein the plurality of read samples include test data having a test data period and wherein the step of generating at least one energy signal is based on at least one sample size, the method further comprises:
selecting the at least one sample size based on the test data period.

14. The method of claim 13 wherein the at least one sample size includes a first sample size for use when the hard disk drive is a perpendicular magnetic recording disk drive and a second sample size for use when the hard disk drive a longitudinal magnetic recording disk drive.

15. The method of claim 12 wherein the step of generating at least one energy signal includes generating a first DFT signal having a first sample size and a second DFT signal having a second sample size.

16. The method of claim 15 wherein the at least one energy signal includes a first energy signal based on the first sample size and a second energy signal based on the second sample size.

17. The method of claim 16 wherein the at least one energy threshold includes a first energy threshold and wherein the step of comparing includes comparing the first energy signal to the first energy threshold.

18. The method of claim 17 wherein the at least one energy threshold includes a second energy threshold and wherein the step of comparing includes comparing the first energy signal to the second energy threshold.

19. The method of claim 17 wherein the at least one energy threshold includes a third energy threshold and wherein the step of comparing includes comparing the second energy signal to the third energy threshold.

20. The method of claim 15 wherein the first sample size is longer than the second sample size.

21. The method of claim 12 wherein the step of generating at least one energy signal generates the at least one energy signal based on the sum of a squared sinusoidal signal and a squared cosinusoidal signal.

22. The method of claim 12 further comprising:
formatting a sector of the disk drive as a bad sector based on the defect data.
